(19) United States
(12) Patent Application Publication
(10) Pub. No.: US 2005/0234921 A1
(43) Pub. Date: Oct. 20, 2005

(54) System and method for automatic domain-name registration and web publishing

(76) Inventors: Raymond King, Portland, OR (US); Kerry Kelley, Portland, OR (US)

Correspondence Address: STOEL RIVES LLP - PDX, 900 SW FIFTH AVENUE, SUITE 2600, PORTLAND, OR, 97204, US

(21) Appl. No.: 11/061,098

(22) Filed: Feb. 18, 2005

Related U.S. Application Data
(60) Provisional application No. 60/545,408, filed on Feb. 18, 2004.

(51) Int. Cl. G06F 7/00

(52) U.S. Cl. 707/10

(57) ABSTRACT

A customer having little or no technical training or experience can publish documents, images and other content to the web using the disclosed methods and systems. A simple e-storefront portal guides the user to selection of a desired domain name, if she does not already have one, and the system registers the domain name automatically to the user. It sets up a virtual server associated with the registered domain name for publication of the user's content. A client application is configured, downloaded and installed on the user's computer desktop. Content dropped into a virtual folder on the desktop is automatically published to the user'

### RELATED APPLICATIONS

This application is a continuation of and claims priority from U.S. Provisional Application No. 60/545,408 filed Feb. 18, 2004.

### TECHNICAL FIELD

The present invention relates generally to the field of web publishing. More specifically, the present invention relates to publishing web documents using techniques that require little or no technical knowledge.

### BACKGROUND OF THE INVENTION

The online population continues to grow rapidly, and as penetration grows, those coming online now are largely made up of “late adopters.” As a result, the average technical capabilities of the average online user worldwide are diminishing, not growing with the age of the Internet, as intuition might suggest.

Today, there are limited options available to non-technical individuals who desire an easy, inexpensive web presence. To succeed with today's products, one must learn or already understand the mechanics of the web, or you can hire experts to do it for you. Even the simplest template-driven web site offerings require a basic knowledge of industry jargon, site construction, and how the Internet plumbing works.

A growing number of online users—who want or would benefit from even a basic web site—are left on the sidelines because there is no option simple enough. Domain registration statistics highlight this into stark relief—under .COM and .NET alone, over 250,000 domain names per month are being let go, many because their owners couldn't figure out how to use them. In addition, a significant share of currently registered domains (approximately 46%) remain unused—or if they have a web site at all, feature only a single page.

This is an un-served market today: those customers who don't know and don't care how it all works. Those who can't or don't want to learn highly technical authoring tools. Those who simply want to put simple information online that others can view with as little time/cost/effort as possible.

As in the early days of the consumer audio industry, a thriving competition in “components,” from hundreds of companies, exists today in the web-publishing world. Customers are able to pick from myriad domain registrars, hosting providers, authoring tools, template designers and more. With some knowledge of the industry—how the components tie together and interrelate—and a goal in mind for what you want to present, you can today create a unique personal or business web site in a couple of hours.

While this may be a relatively quick and easy process for some, it may not be quite so easy for others. For example, some people have no idea where to start and have no one to help them in the website creation/deployment process. Many people do not understand the jargon or how any of the technical pieces fit together. There is a confusing array of options and service providers. Time, money and other resources for use in maintenance & design are limited.

In some situations, a user wants to publish on the web, but does not want to learn a web authoring software tool. Moreover, the specific need may be temporary, or the contents may change frequently, demanding more effort and expense. In other cases, the content to be published may be very simple, and therefore not justify the currently required cost in time or effort.

Unlike consumer audio, there is no all-in-one integrated solution that you can simply bring home, plug in and enjoy. Yet, the evidence points to a growing audience and potential demand for a simple integrated service targeted to those who would like to:
Personally publish something to the web;
without having to learn anything new;
without needing any additional service or support from others;
having the ability to update it as frequently as they like; and easily “throw it all away” when they are done.

Thus a need remains for systems and methods to enable a user, especially a non-technical user, or one who does not have a domain name registration, to publish content on the web using techniques that require little or no technical knowledge. Prior art products are known to facilitate generation of HTML web page content, but they do not provide a seamless, automated process from selection of a desired domain name through publication on the web.

Various aspects and advantages of the present invention will become apparent from the following detailed description of preferred embodiments, which proceeds with reference to the accompanying drawings.

### BRIEF DESCRIPTION OF THE DRAWINGS

FIG. 1 is a block diagram of a system architecture according to an embodiment of the invention.

FIG. 2. is a flow chart of a method for automatic domain name registration and web publishing according to an embodiment of the invention.

FIG. 3 illustrates a number of subtasks that may be performed by one embodiment of the invention.

FIG. 4 is a high-level data flow diagram according to an embodiment of the invention.

FIG. 5 is a data flow diagram showing the creation of an account according to an embodiment of the invention.

FIG. 6 is a data flow diagram showing the automatic updating of a site according to an embodiment of the invention.

FIG. 7 is a block diagram of a software client architecture according to one embodiment of the invention.

### DETAILED DESCRIPTION OF THE PREFERRED EMBODIMENT

The present invention solves the above-identified problems and disadvantages by providing a level of service integration and ease of use that breaks new ground in the web hosting and domain registration industries. Literally anyone can succeed using the present invention with the most basic desktop computer skills.

The present invention relates to a tightly integrated combination of desktop software, domain registration service, file transfer software, file translation software and hosting service, that enables drag & drop publishing of Microsoft Office (and other) documents, photos, PDF files, and more. No HTML experience is required. No tools or knowledge other than what the customer already possesses are required.

In one embodiment, a customer simply visits a web site (e.g., www.namedropper.com), chooses a domain name for a personal site and selects a simple service plan. Software is automatically added to the desktop in the form of a simple drop folder that allows instant publishing of Office documents to the own personal Web site.

The present invention relies solely on a user's existing knowledge of how to manipulate the Windows desktop—drag & drop, use of folders—and basic Office applications like Internet Explorer, Word, Publisher, PowerPoint and Excel.

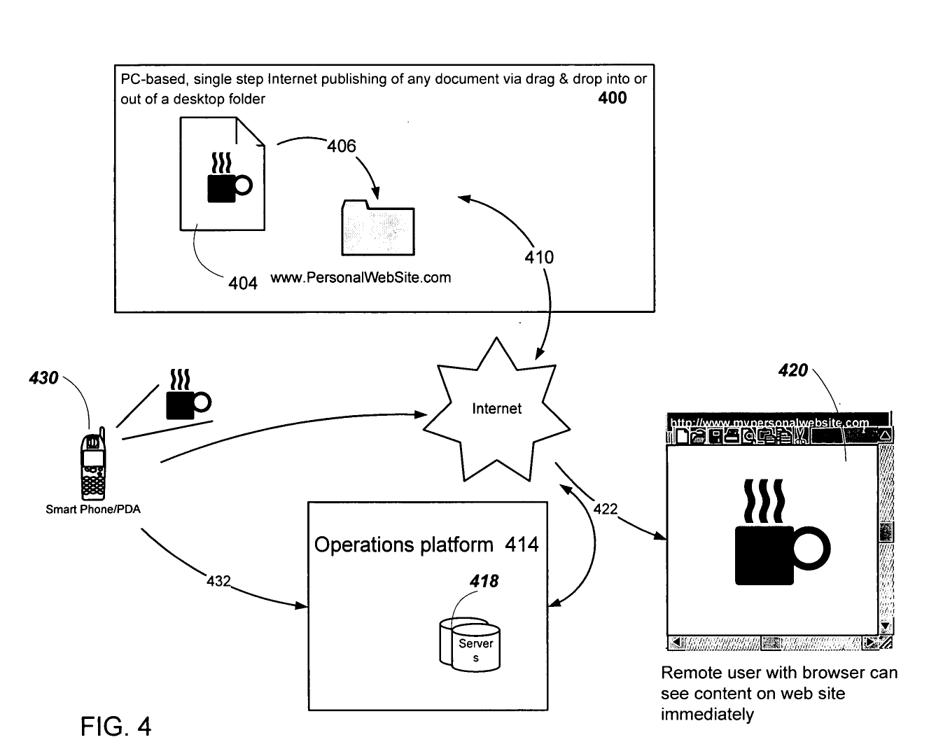

FIG. 4 is a simplified, high-level diagram of an Internet publishing system and methods in accordance with one embodiment of the present invention. In FIG. 4, a client computer 400 such as a PC or the like, provides a simple and convenient interface for a user to publish desired documents on the Internet without any particular training or familiarity with Internet publishing technologies. A client program described in further detail below, implements a “virtual folder” 402 at the user's machine 400, preferably presenting a graphical icon on the “desktop”. This can have the familiar appearance of a file folder, or, preferably, it can display a distinctive logo to indicate its special purpose as a web publishing folder.

A document 404 is either imported or created on the user machine 400. The term “document” is used here in its broadest sense; referring to almost any electronic file. Typically, it is likely to comprise a word processing document, a PowerPoint presentation, an image, a video clip, etc. In this simple illustration, document 404 includes an image of a coffee cup. In FIG. 4, because the virtual folder 402 is shown on the user's desktop 404, it is presumed that the user has already established a virtual web server using the process that will be explained below.

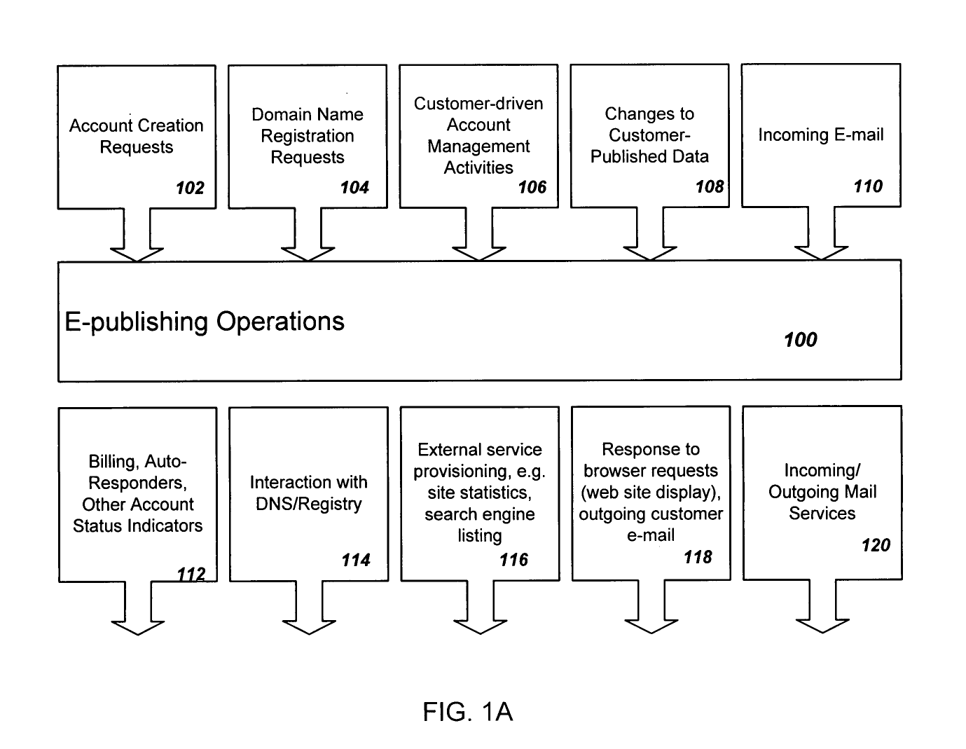

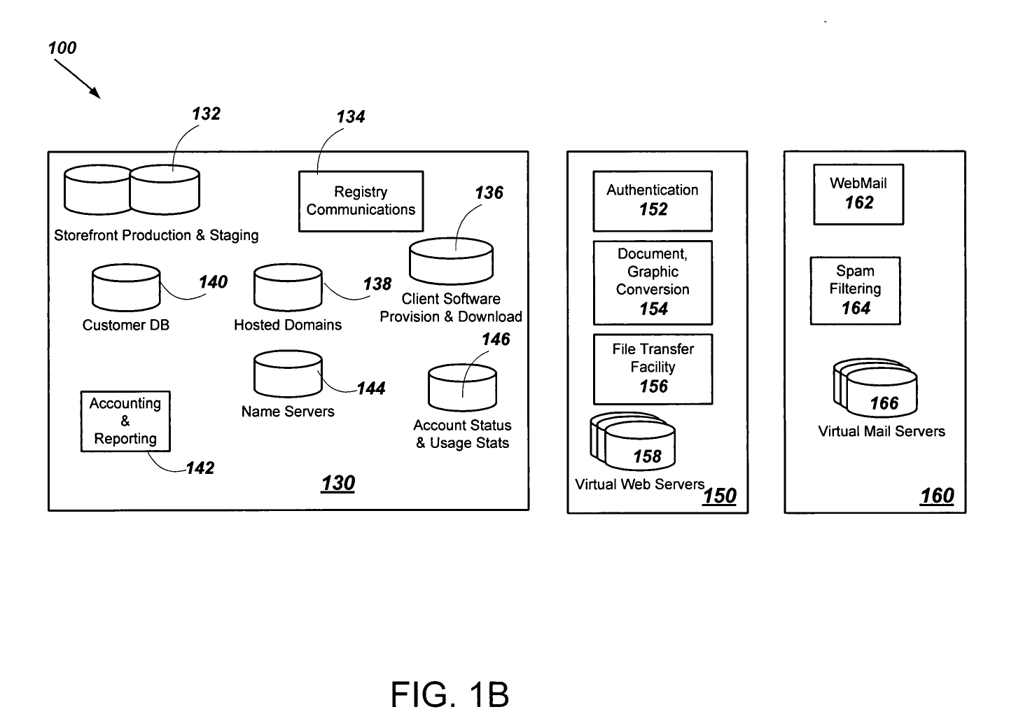

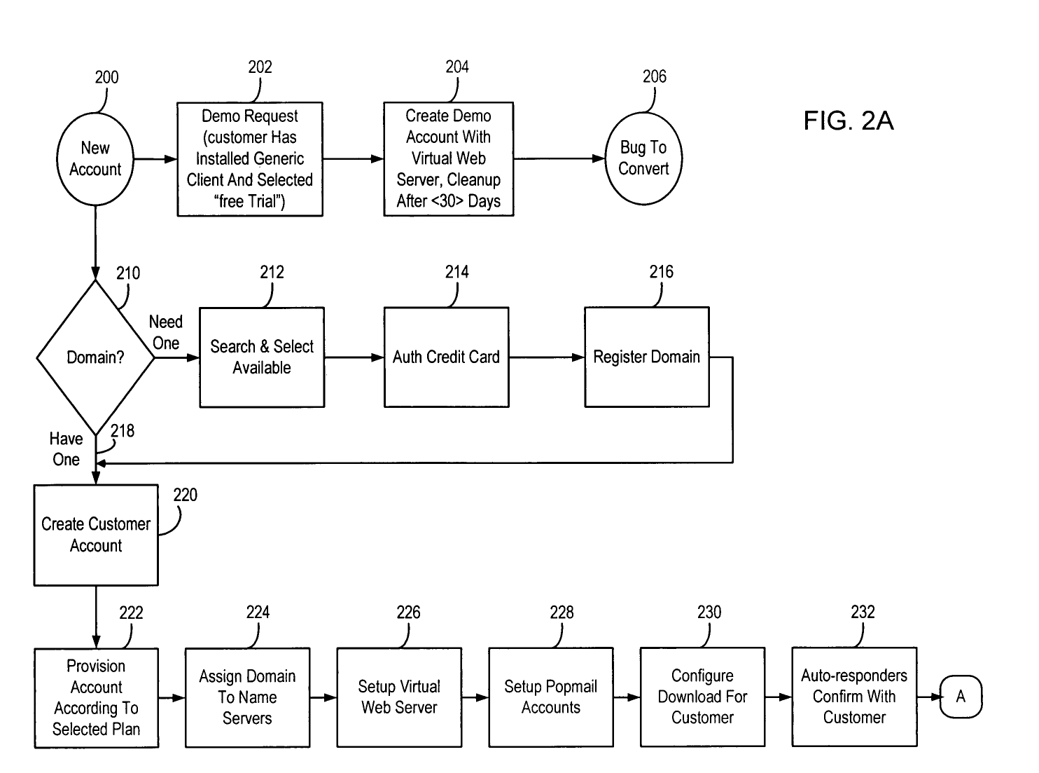

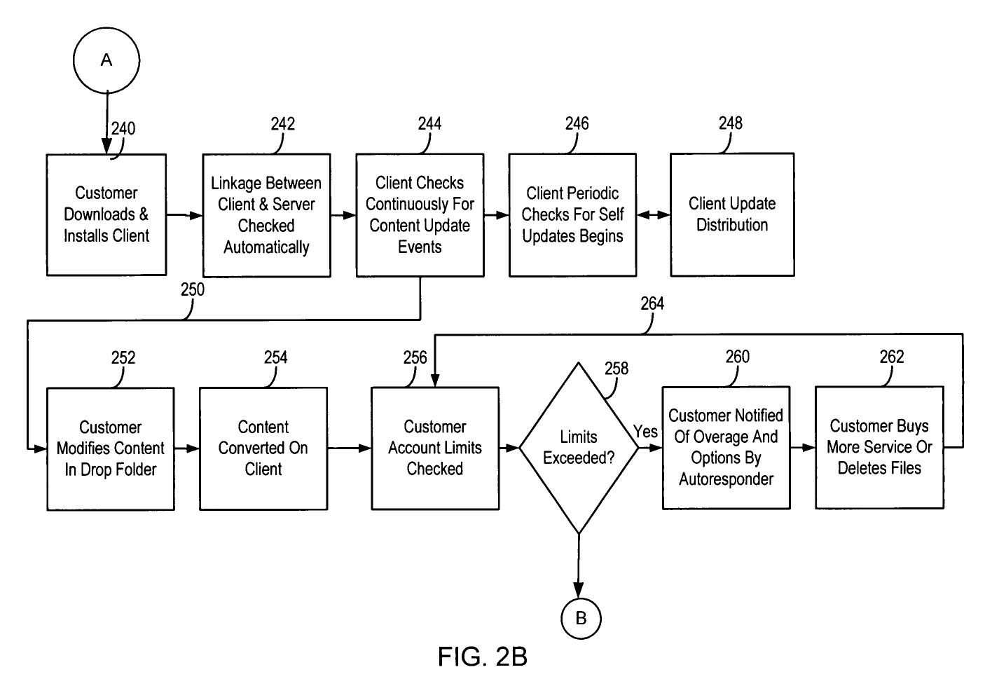

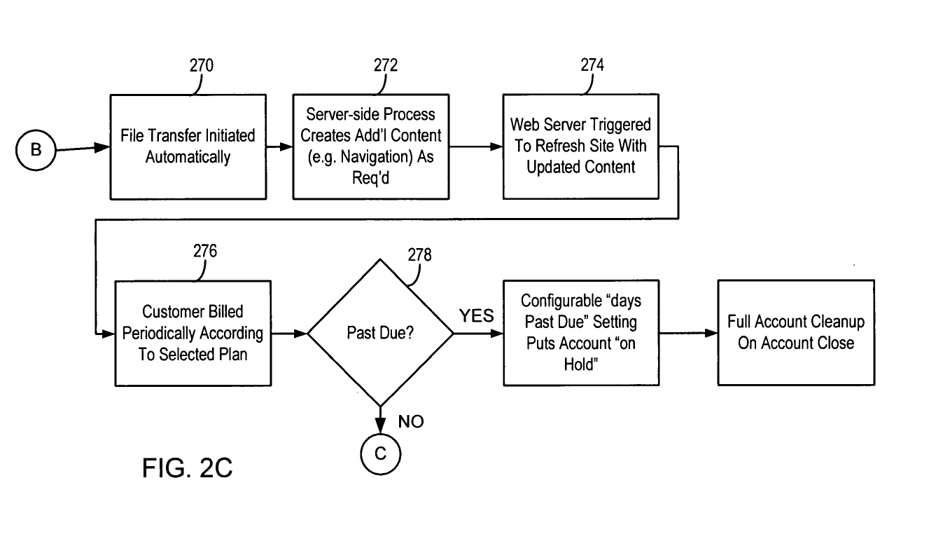

In operation, a user can publish any desired document by depositing the file into the virtual folder 402 on the desktop. This can be done, for example, using the familiar “drag and drop” user interface. Here, the arrow 406 indicates that the user drops the document 404 into the virtual folder 402. When this occurs, the client program detects a change in the contents of folder 402 and automatically communicates that change using a message or session 410, transmitted via the Internet 412 to an operations platform 414. In some embodiments, the operations platform 414 corresponds to the operations platform described below with reference to FIGS. 1 and 2.

The operations platform 414, which can be implemented as a web server, receives the information through any electronic network and automatically prepares the content, in this case file 404, for web browser display. This may require some transformation, as discussed later. The content file, potentially translated or transformed to an alternative format, is then made available on a virtual web server 418 which could be co-located with the operations platform 414 or deployed at some other location or network having a communication link to the operations platform 414. The web server 418 is of course coupled to the Internet 412. Once the content is published on the customer's virtual website, it becomes accessible to the general public, via the Internet 412 and a suitable web browser. A remote user with a browser can see the published content (corresponding to document 404—the coffee cup image) on the website immediately as indicated at web browser display 420. The remote user is of course connected to the Internet via 422 (typically via an ISP).

Another remote user might access the web server 418 from a smart phone, camera or other PDA 430. This device might access the web server 418 via the Internet 412 or through an alternate network, for example a private network, illustrated as 432. The website content will be displayed at the wireless device 430. The content may be modified for display on a wireless device, for example using the WAP methods and protocols. Conversely, a smart phone, PDA or other mobile device can be used to transmit text messages, photos and other content to the web site for automatic posting. In this scenario, the web server is programmed, through scripting or the like, to forward the incoming content to the operations platform for processing and posting to the web site as if it had originated at the user's desktop. This feature is especially useful for a mobile customer. The operations platform preferably is arranged to receive information through any electronic network. Further, the user's account can be configured at the operations platform to forward incoming information to the user's desktop virtual folder. In this way, the user can conveniently receive and store content from remote devices, including but not limited to her own mobile devices.

While the present description refers to a single customer or user publishing content via the web, the invention is not limited to a single user or desktop publication folder. The system can be configured to enable multiple users, or more specifically multiple client instances, to publish on the same site, as well as effect updates or revisions. An appropriately configured client application is downloaded and installed, as further described below, to each user's desktop. Each instance is configured to “point to” the same site. The users can share access to the same pages, with due regard to coherency. Alternatively, or in addition, they can each have exclusive pages for their use. The automatic table of contents, described later, can distinguish by user, or generate one unified table of contents.

The setup of this system in one embodiment and its operation are discussed next, with reference to FIG. 1A. FIG. 1A is a conceptual diagram of a publishing operations platform 100. FIG. 1A illustrates along the top some of the typical input actions and information received by the publishing operations platform 100 (hereinafter simply “the platform”). First, the platform 100 can receive account creation requests 102. In one embodiment, the publishing platform is implemented on a web server, and account creation requests can be received through a web page interface, the particulars of which are known and therefore omitted here.

The account creation process is described further below with reference to FIG. 2. The platform 100 also receives domain name registration requests 104 which may be a part of the account creation request 102. The platform also receives and processes various customer-driven account management activities 106 and, the platform 100 can also implement email services and accordingly it receives incoming email 110. Finally, the publishing platform receives changes to customer-published data 108. This refers to information that is transmitted to the operations platform as a consequence of a change to the content of the customer's publishing folder 402 in FIG. 4 as described above. The platform operations that result from various changes to customer-published data are described further below with reference to FIG. 2.

Referring again to FIG. 1A, the publishing operations platform 100 provides a variety of services and outputs, including the following: First, it interacts with the Internet domain name system (DNS) and domain name registration authorities, 114. As shown below, these services are implemented in order to find an available domain name for a user and secure a registration of that domain name. The registered domain name will then be assigned to a web server (418 in FIG. 4) for publishing the publisher's content. If the user already has a domain name registered, and wishes to use that domain for web publication, the domain name and related information can be input to the operations platform, and the servers and client software, described below, will be configured to publish at that domain. The platform also provides outgoing mail services 120. Further, the platform 100 can be configured to respond to web browser requests to access the customer's website. This refers to the web server functionality, corresponding to server 418 as discussed above with reference to FIG. 4.

Additionally, the platform 100 provides billing, auto-responders and other account status indicators 112 and it can be configured to provide external services such as site statistics, search engine listings, etc. 116. Various known billing methods can be used, some of which are effected online, and which can include credit card charges, ETF from a bank account, and so on. These functions are described by way of illustration and not limitation. In general, the publishing operations platform 100 provides all of the services necessary for the customer to enjoy the benefits of publishing on the Internet without involving himself in the technical details.

FIG. 1B illustrates the principal components of the platform 100 in somewhat greater detail. In this illustration, the principal software components and databases of the platform 100 are grouped into three functional sets. The first group 130 illustrates the primary components for domain name registration and web page publication, as well as account maintenance and reporting functions. The second functional set 150 refers to actual publication of documents via one or more web servers. This includes the functions of authentication of input documents 152, document and graphic conversion as necessary 154 and finally, file transfer facilities 156 for publishing the content to one or more virtual web servers 158. The third functional set 160 is directed to email services. It includes web mail component 162, spam filtering 164 and, of course, one or more virtual mail servers 166. Those skilled in the art will appreciate that the functional components could be implemented on a single server or distributed over two or more servers at a common site or multiple remote sites.

Returning to the functional set 130, it includes storefront production and staging operations 132, registry communications component 134, client software provisioning and downloading component 136, hosted domains database 138, customer database 140. In a presently preferred embodiment, this platform also includes account status and usage statistics component 146, name servers 144 and accounting and reporting functions 142.

FIG. 2 is a flowchart illustrating typical operations of the publishing platform in one embodiment. Referring now to FIG. 2A, a potential customer contacts the platform server at step 200 to establish a new account. In step 222, the customer requests a temporary or demo account, having installed generic demo client software. In response to this request, step 204, the platform creates a demo account with the virtual web server. The demo account lasts for a predetermined time period such as 30 days. After the account is established, in step 206, the process occasionally reminds the customer of the option and the need to convert to a regular account. This reminder process naturally terminates at the end of the demo period.

Alternatively, the customer or potential customer is seeking to establish a regular account. A query 210 determines whether or not the customer already has a registered domain name. If a domain name is needed, the system can conduct a search, step 212, and assist the customer in selecting an available domain name. For example, software is known for checking domain name availability and for suggesting alternatives that are similar to a desired domain name that is not currently available. After a domain name is selected, the system attends to credit card authorization for payment, step 214, and then registers the desired domain name, step 216. Typically, the registration process is carried out through the auspices of an authorized domain name registrar. After domain name registration is completed, or if the customer already has a domain name, branch 218, the system sets up a customer account, step 220. It may be recalled in the discussion above that an illustrative publishing operation platform (100) includes a customer database and related functionality, described above with reference to FIG. 1.

In 222, the new account is provisioned according to a selected plan. For example, various plans could be implemented, at various price points, to accommodate the size of the customer website, number of email accounts, document translation services, etc. Next, in 224, the registered domain name is assigned to the virtual web server. In step 226, the virtual web server is set up to implement the customer's website. Email accounts such as pop mail accounts are established, step 228.

Continuing, in step 230, a download package is configured for the customer. This download package will include client software for implementing a virtual folder or publishing folder on the desktop, for web publishing operations as described above with regard to FIG. 4. Preferably, the download includes automatic responding components that confirm receipt of the download, step 232. Thus the procedures illustrated in the flowchart of FIG. 2A summarize the initialization of a new customer account, assignment of a website domain name, and delivery of the client side software to the customer.

Referring now to FIG. 2B, in accordance with one embodiment of the invention, the customer then installs the client software, step 240, on his or her machine. The customer's machine can be any of a wide variety of electronic devices that can execute code and handle files and folders. It also needs to have network connectivity as mentioned earlier, with regard to the PC 400 and PDA/wireless device 430 of FIG. 4. In step 242, linkage between the client software and the server the associated server is checked automatically. At this juncture, the virtual folder (402 in FIG. 4) is now deployed on the user's electronic desktop and is active to receive files. The client software continuously checks for content update events. In the simplest case, such events would include the addition of a new file to the folder, or deletion of a file from the folder.

When there is a change to the content, the process branches via 250, as discussed shortly. Until there is a content update event, the client software continues periodic checks for self-updates, in other words, updates to the client software itself, step 246. When it detects such an update, the client software will download its own update distribution, step 248. As noted, when a content change is detected at step 244, the process branches via 250. For example, in 252, the customer has modified the content of the publishing folder. At step 254, the client software automatically converts the new file, as necessary for publication.

Next, step 256, the client software checks to determine whether customer account limits will be exceeded by publication of the update. Indicia of the customer account limits or parameters can be maintained at the client side, as well as at the host side (the publishing operations platform of FIG. 1). If the limits are exceeded, step 258, the software notifies the customer of the problem and presents options to resolve it, step 260. In step 262, the customer purchases additional services if required, or deletes files if necessary to comply with applicable space limitations. If the limits are not exceeded, the process continues at Label B on to FIG. 2C.

Referring now to FIG. 2C, the new content is ready for publication, and the client side software automatically initiates transfer of the file to a server-side process, step 270. In 272, a server side process creates the additional content as required. For example, the newly added content may require some navigational links, updating a table of contents, site index or the like. This is done automatically. Next, at step 274, the web server is triggered to refresh the site with the updated content. Of course, the foregoing steps are repeated as may be triggered by updates detected on the client side at step 244 of FIG. 2B. Next, the customer is billed periodically, step 276, in accordance with the selected service plan. The billing components are described above with reference to FIG. 1. Step 278 tests whether the customer payment is past due. If so, step 280, the account may be placed on hold and there is a full account cleanup when an account is finally closed, at step 282. At step 278 once again, if the account is not past due, the process is completed.

To summarize, in one presently preferred embodiment, an implementation of the invention can provide an active drop folder on the user's desktop—tightly integrated with a hosting service and user—s choice of domain name—that enables instant online publishing. It lets anyone, regardless of technical ability, instantly publish documents—using tools they are already familiar with—to the World Wide Web. Thus aspects of the invention can be described as a simple to use, tightly integrated replacement for a number of products and services that in prior art must be purchased discretely and configured manually; eliminating the need for significant technical know-how, time, cost, and/or outside support.

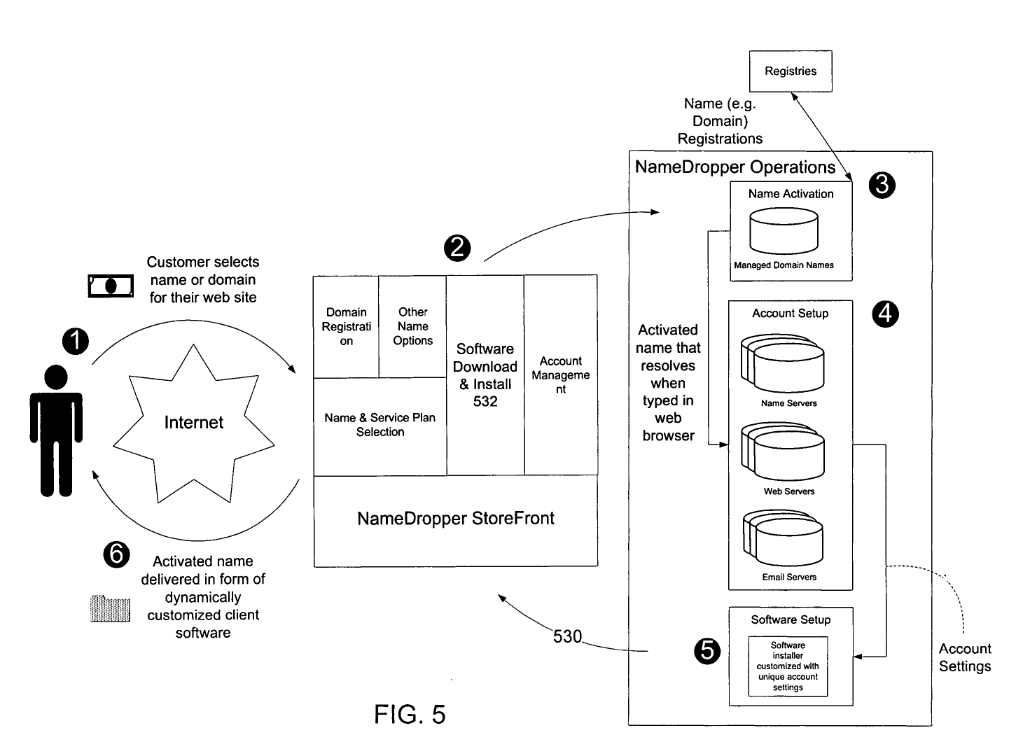

FIG. 5 further illustrates the new account setup process. At (1), a customer accesses the NameDropper Storefront web site (2) via the Internet, and selects a name or domain for their new web site. A fee may be collected. (The term NameDropper as used herein is merely an arbitrary shorthand for an automated web publishing service and system that embodies aspects of the present invention.) The NameDropper storefront system or “platform” (2), preferably comprising a web site/web server, includes software components such as those shown in the drawing, to interact with the customer and manage, for example, (a) name and service plan selection; (b) software download and install interactions with the customer; (c) and account management.

The NameDropper platform invites the customer to input a desired name or key word. From that, it generates potential domain names, and may present various alternatives to the customer for selection. Before or after tentative selections, the platform queries the DNS system, for example using a WHOIS command, to determine availability of the selected name(s). The interactive process continues until the user selects a desired name that is available for registration. Customer contact information, billing information, and service plan options are collected to setup the customer's automated web publishing account.

Next the storefront platform communicates with a NameDropper Operations system. These communications preferably are “behind the curtain” meaning essentially that they occur with little or no exposure to the customer. In some embodiments, the storefront platform may display encouraging messages to the customer, e.g. “We are now setting up your web site domain name” or the like. The operations platform and its functionality were described earlier with regard to FIG. 1.

Referring again to FIG. 5, the storefront platform communicates customer data and preferences to the operations platform. At label (3), the operations platform attends to registration of the selected domain name. This is done through the auspices of an authorized domain name registrar. Here, the NameDropper service itself may be offered by a registrar or affiliated with a registrar, in which case it could register the name directly with the appropriate domain name registry. Importantly, the domain name registration process proceeds without interaction with the customer; it is done automatically in the background. The operations platform maintains a database of its managed domain names.

As illustrated, the operations platform (which need not be one computer or physical location but may be distributed) sets up the customer account in name servers, web servers and email servers to provide the respective services, illustrated at label (4).

Next, at label (5) in FIG. 5, a client software instance is created for this customer. The software installer is customized with unique settings for this user account and domain name. The client software package is transferred to the storefront, as indicated by arrow 530. The storefront platform software download and install component 532 in turn communicates with the customer to download and install the client software on the customer's computer. See label (6) in FIG. 5: the activated domain name is “delivered” in the form of the dynamically customized client software. The customer sees simply a special folder icon on the “desktop”. As discussed earlier, the customer can “drag and drop” content here for automatic publication on her web site, which is now active at the domain name selected by the customer.

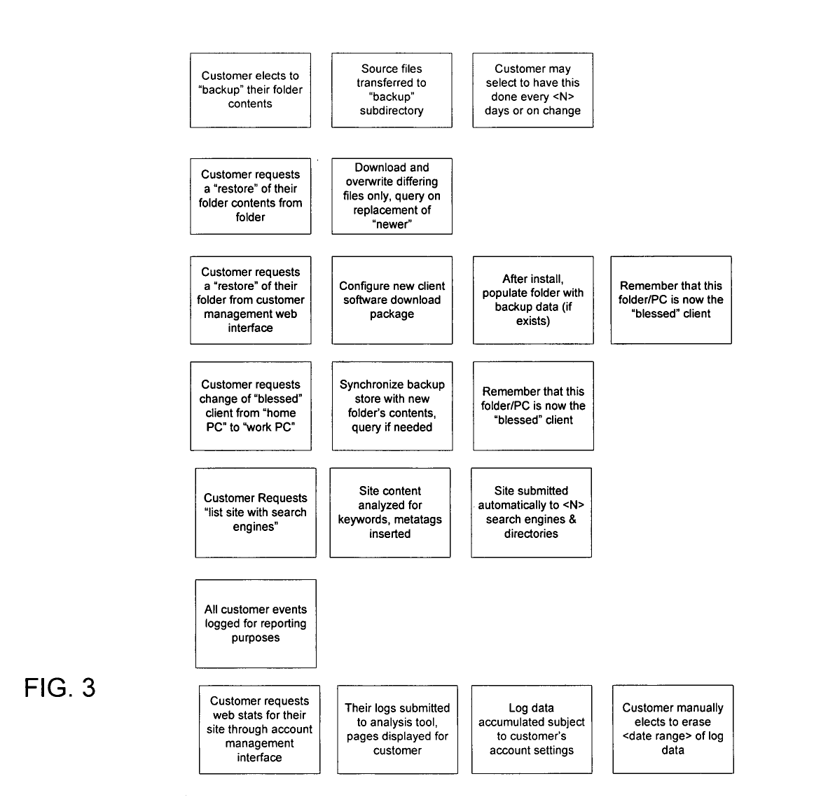

Additional representative subtasks are shown in FIG. 3. Referring now to FIG. 3, a customer elects to “backup” their folder contents. Source files are transferred to a “backup” subdirectory. Customer may select to have this done every <N> days or on change to the folder. As another example, the customer requests a “restore” of their folder contents. The system can download and overwrite differing files only, query on replacement of matching file names to use newer version or not.

A customer might also request a “restore” of their folder, i.e. the client software, from a customer management web interface. The operations platform will configure a new client software download package. After install, the platform can populate the folder with backup data (if it exists). The platform will recognize going forward that this new folder/PC is now the authorized client.

Referring again to FIG. 3, the customer can request a change of “blessed” (authorized or live) client from “home PC” to “work PC” for example. The system, in response, can synchronize backup store with new folder's contents, and query if needed. In this regard, multiple clients (users) can be authorized as well, so that a work group can jointly publish and maintain content. And, as noted above, one or more of the authorized content source clients may be mobile. Preferably, all customer events are logged for reporting and billing purposes.

Customer requests web stats for their site through account management interface. Their logs are submitted to analysis tool, and pages are displayed for the customer. Log data is accumulated subject to the customer's account settings. The customer manually elects to erase <date range> of log data. None of this requires technical expertise on the part of the user.

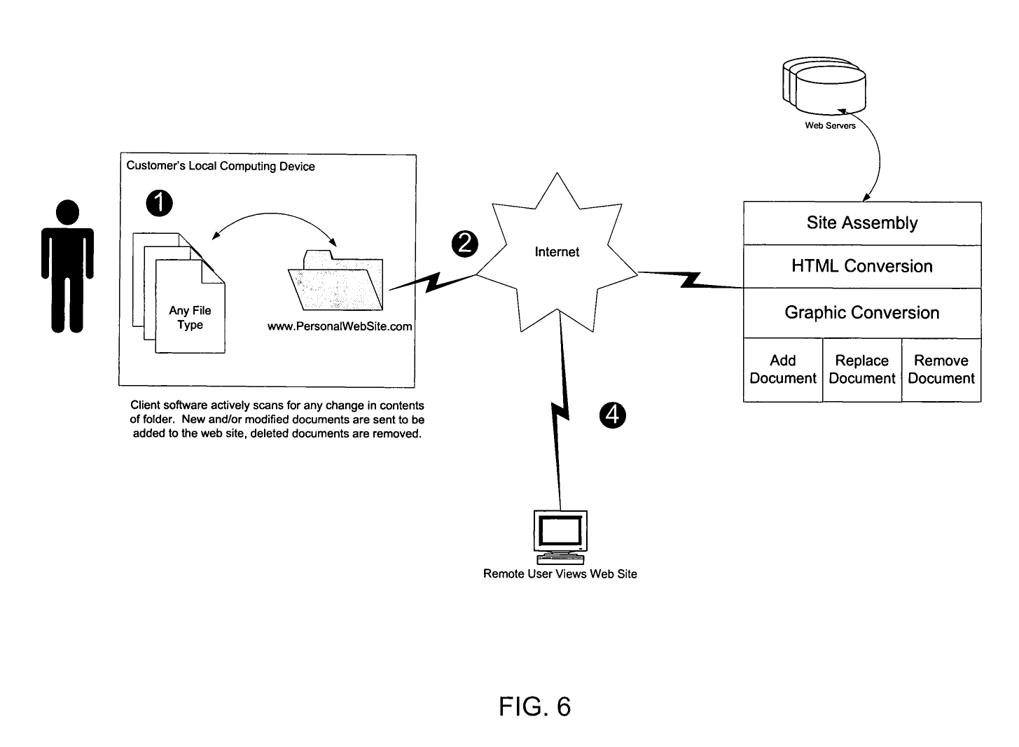

FIG. 6 illustrates how the automated web publication can be implemented in greater detail. In FIG. 6, label (1), the customer can simply “drag and drop” content, in any file type, into the web publication folder (illustrated as www.PersonalWebSite.com). The client software actively scans for changes to contents of this folder. New or modified documents are sent automatically to a system (which can be part of the operations platform above) for addition to the customer's web site. Conversely, removal of a document from the web publication folder will trigger a message to remove same from the web site.

When a document is added for publication, the client software in one embodiment converts the document, or more specifically its content, to a standard markup language, e.g. HTML. Then, the HTML document, rather than the original source document, is uploaded to the web site. There is no actual link to the source document. In the web site server or at the operations platform, a table of contents is created/updated automatically. The TOC links to the HTML documents, not to the original source. The operations platform will also perform necessary graphics conversions and assemble content for distribution to the web servers. Thereafter, any remote user can visit the site via the Internet to view the customer's content (label 4).

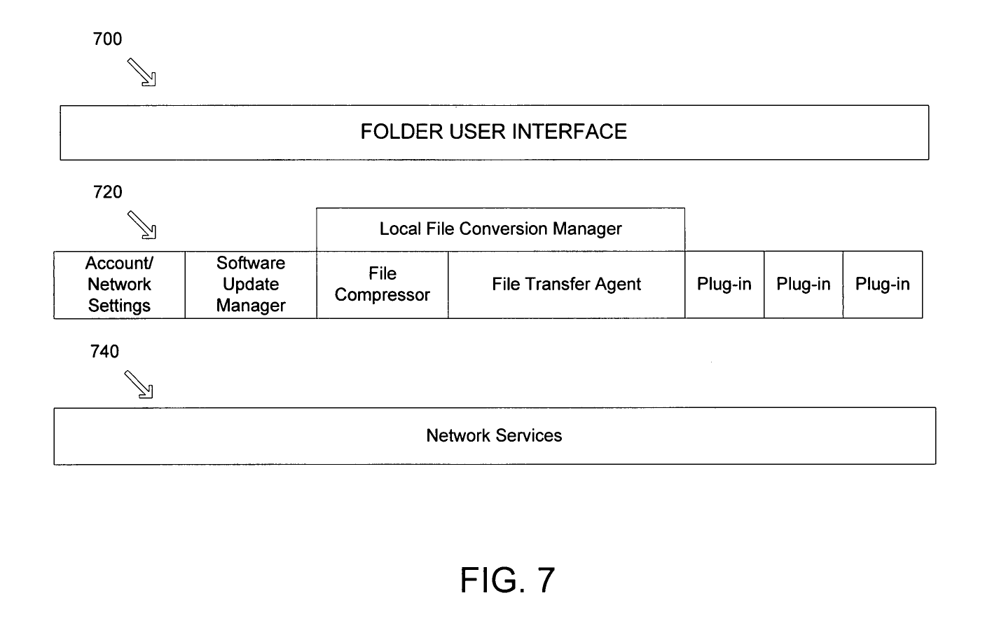

FIG. 7 a block diagram of a software client architecture according to one embodiment of the invention. The drawing illustrates a software “stack” beginning with network services 740 at the lowest level. The client software interacts with network services for communications services and the like. At the top level, corresponding to the user interface, a “folder user interface” 700 is implemented. This refers to the automatic web publication desktop folder described earlier. It provides a simple, intuitive interface for the customer to effectively add, update or remove content from its web site using only a “drag and drop” action.

Logically intermediate the network services and the user interface are various functional elements 720. Examples shown in the drawing for one embodiment include account and network settings or configuration data; details of which were described earlier. A software update manager module attends to updating the client software by receiving and installing updates from a remote server, for example the operations platform, with little or no customer interaction. For example, functional improvements or patches may be downloaded. Or, the user may upgrade to a different service level which, in turn, requires an update to the client software.

It will be obvious to those having skill in the art that many changes may be made to the details of the above-described embodiments without departing from the underlying principles of the invention. The scope of the present invention should, therefore, be determined only by the following claims.

1. A method for automatically creating a website comprising:
receiving a user selection of a domain name;
automatically registering the selected domain name;
automatically creating a virtual web server to host user content;
creating a virtual folder client application that links a desktop of the user to the virtual web server; and
downloading the virtual folder client application to the user's desktop.

2. The method of claim 1, wherein downloading the virtual folder client application comprises downloading and installing client software to a computer of the user that implements the virtual folder.

3. The method of claim 1, wherein automatically registering the domain name comprises associating the selected domain name to an IP address of the virtual web server.

4. The method of claim 1, further comprising automatically configuring at least one email account to be accessible via the registered domain name.

5. The method of claim 1, further comprising:
receiving a first content file added to the virtual folder by the user;
in the user computer, extracting content from the first content file; and
automatically publishing the extracted content on the virtual web server.

6. The method of claim 5, wherein automatically publishing comprises automatically converting the content file into a markup language.

7. The method of claim 5, wherein the original content file is added to the virtual folder by a graphical user interface drag and drop operation.

8. The method of claim 5, wherein said automatically publishing comprises automatically converting at least a portion of the content into HTML.

9. The method of claim 5, wherein automatically publishing comprises automatically converting a graphic from the content file into a predetermined graphic format for publishing the graphic on the virtual web server.

10. The method of claim 5, wherein automatically publishing comprises sending the content to a remote web server for publication on the web at the registered domain name site.

11. The method of claim 5, wherein automatically publishing comprises sending the content to a remote operations platform for processing; and wherein after said processing, the operations platform updates a web page to incorporate the content for publication on the web at the registered domain name site.

12. The method of claim 5, further comprising:
receiving a second document dropped into the virtual folder by the user;
creating a table of contents page listing and providing a link to the first and second documents; and
automatically publishing the table of content page on the virtual web server.

13. A method for automatically creating a website comprising:
establishing an account online for a web publishing customer;
if the customer has a registered domain name, receiving from the customer identification of the registered domain name;
if the customer desires a domain name registration, receiving from the customer a selection of a desired domain name, and automatically registering the selected domain name to become the registered domain name;
automatically creating a virtual web server to host user content;
associating the virtual web server with the registered domain name so that web pages are accessible at a network address corresponding to the registered domain name;
creating a virtual folder that links a desktop of the customer to the virtual web server;
downloading the virtual folder to the user's desktop;
monitoring the virtual folder to detect an update event initiated by the user; and
performing a publishing action in response to the update event.

14. The method of claim 13, wherein the update event comprises the user modifying a document within the virtual folder, and wherein the publishing event comprises modifying a corresponding document being published on the virtual web server.

15. The method of claim 13, wherein the update event comprises the user deleting a document within the virtual folder, and wherein the publishing event comprises removing a corresponding document from the virtual web server.

16. The method of claim 13, wherein the update event comprises the user removing a document from the virtual folder, and wherein the publishing event comprises removing a corresponding document from the virtual web server.

17. The method of claim 13, wherein the update event comprises the user adding a document to the virtual folder, and wherein the publishing event comprises adding a page to the virtual web server corresponding to the document added to the virtual folder.

18. A web publication method comprising:
establishing an electronic storefront portal for web publication;
at the storefront portal, interacting with a user to select a desired domain name that is either registered to the user, or available for registration to the user;
if not registered to the user, registering the desired domain name to the user;
automatically creating a virtual web server to host user content;
associating the virtual web server with the registered domain name so that web pages are accessible at web site having a network address corresponding to the registered domain name;
creating a virtual folder that links a desktop of the customer to the virtual web server;
downloading the virtual folder to the user's desktop; and
publishing content submitted to the virtual folder at the web server.

19. A web publication method according to claim 18 and further comprising:
accessing the web site from a smart phone, camera or other mobile device; and downloading a web page to the mobile device that reflects the content submitted to the virtual folder in a modified format.

20. A web publication method according to claim 19 and further comprising:
uploading new content to the web server from the mobile device; and
automatically forwarding the new content to the user's desktop virtual folder.
